(19) United States
(12) Patent Application Publication
(10) Pub. No.: US 2009/0135610 A1
(43) Pub. Date: May 28, 2009

(54) Recessed light fixture for luminous ceilings

(76) Inventor: Jack V. Miller, Seaford, DE (US)

Correspondence Address: Jack V. Miller, 20915 Sussex Hwy., Seaford, DE, 19973, US

(21) Appl. No.: 11/986,654

(22) Filed: Nov. 26, 2007

(51) Int. Cl. B60Q 1/00

(52) U.S. Cl. 362/370

(57) ABSTRACT

The present invention is for a compact, light-weight, inexpensive, spider-shaped light fixture for luminous ceilings in which the fixture comprises a housing in the form of an inverted U-shaped reflector located above and between T-bar runners, with angular struts attached to the housing and extending out to be engaged onto the tops of T-bar runners on either side of a luminous-ceiling panel. The housing includes one or more self-ballasted, scew-based compact fluorescent and/or optional incandescent lamps that are installed into 3-way, remotely-switched lampholders capable of operating either 3-way, single-circuit incandescent, or various gas-discharge lamps.

### U.S. PATENT REFERENCES CITED

U.S. Pat. No. 6,402,349—Miller, et al

U.S. Pat. No. 3,790,774—Miller

U.S. Pat. No. 6,260,981—Fiene

Ser. No. 11/881,787—Miller {PTMS application filed Jul. 30, 2007)

### FIELD OF THE INVENTION

The present invention relates to the field of recessed light fixtures, and more specifically to light fixtures suspended over luminous ceiling panels, as commonly used in commercial buildings.

### BACKGROUND OF THE INVENTION

Luminous ceilings are translucent or clear prismatic panels resting on the flanges of inverted T-bar runners and cross tees forming a grid. The most common T-bar grids are 2 by 2 foot squares that support square recessed light fixtures like that shown in prior art FIG. 1, or 2 by 4 foot rectangles that support rectangular recessed light fixtures like that shown in prior art FIG. 2. Other T-bar grid systems do not support fixtures, which are instead supported from an overhead ceiling as shown in prior art FIG. 3. Most such recessed light fixtures employ straight fluorescent lamps in 2-foot, 4-foot or 8-foot lengths, with bi-pin lamp sockets at each end as seen in FIG. 3 and have central ballast housings as shown in prior art FIG. 4, taken from applicant Jack Miller's U.S. Pat. No. 6,402,349. Such fixtures as shown are large, heavy and costly to make, package and ship. The recent availability of screw-based compact fluorescent lamps makes luminous ceiling fixtures like the present invention possible and practical.

### SUMMARY OF THE INVENTION

The present invention as shown in FIG. 5 is for a compact, light-weight, inexpensive, spider-shaped light fixture for luminous ceilings in which the fixture comprises a housing in the form of an inverted U-shaped reflector located above and between T-bar runners, with angular struts attached to the housing and extending out to be engaged onto the tops of T-bar runners on either side of a luminous-ceiling panel. The housing includes one or more self-ballasted, scew-based compact fluorescent and/or optional incandescent lamps.

### BRIEF DESCRIPTION OF THE DRAWINGS

FIG. 1 is a perspective view of a typical prior art 2×2 (24-inch square recessed light fixture for T-bar suspended ceilings;

FIG. 2 is a perspective view of a typical prior art 2×4 (24 by 48-inch recessed light fixture for T-bar suspended ceilings;

FIG. 3 is a perspective view of a prior art T-bar grid ceiling shown suspended below an overhead-mounted fluorescent light fixture;

FIG. 4 is a transverse cross-sectional view of a fluorescent light fixture including a pyramidal lens disposed above a flat prismatic lens as shown in the applicant's U.S. Pat. No. 6,402,349;

FIG. 5 is a perspective view of a recessed light fixture according to the present invention, shown attached to suspended ceiling runners;

FIG. 6 is a transverse cross-sectional view of a recessed light fixture according to the present invention, including a pyramidal lens disposed above a flat prismatic lens as shown in the applicant's U.S. Pat. No. 6,402,349 and supported on struts attached to ceiling runners;

FIG. 7 is a transverse cross-sectional view of the housing and lampholder of the recessed light fixture according to the present invention;

FIG. 8 is a perspective view of a recessed light fixture according to the present invention, showing the support struts nested for packing and shipping;

FIG. 9 is a vertical plan view of view of an embodiment of the recessed light fixture according to the present invention, taken along view line B-B of FIG. 6; and

FIG. 10 is an illustration of a partial number of lamps usable in screw-base socket(s) as shown in FIG. 9.

### DETAILED DESCRIPTION OF THE DRAWINGS

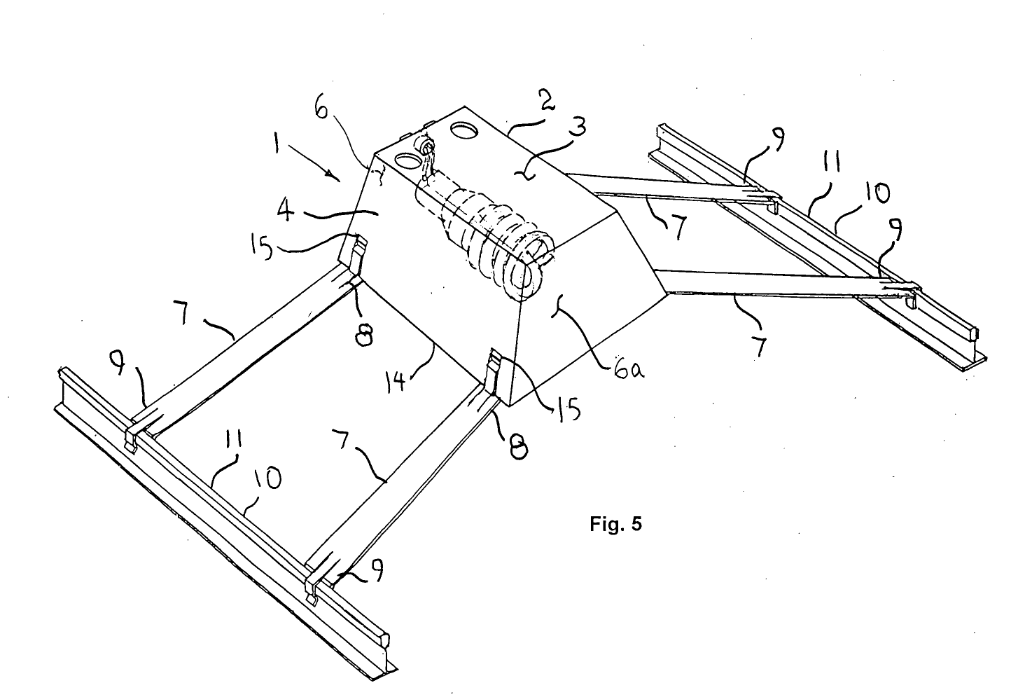

In FIG. 5, a perspective view of the compact spider light recessed light fixture (1) according to the present invention, has a reflective, inverted U-shaped housing (2) having a central horizontal base (3) and a pair of depending sides (4) and closure ends (6, 6a). Each depending side (4) as a lower distal edge (14) attached to a pair of elongated, angular struts (7) having proximal ends (8) that snap into apertures (15) on the distal edges (14) of sides (4). Said struts extend out at an obtuse angle to their distal ends (9) that snap onto the bulbous tops (10) of spaced apart T-bar runners (11).

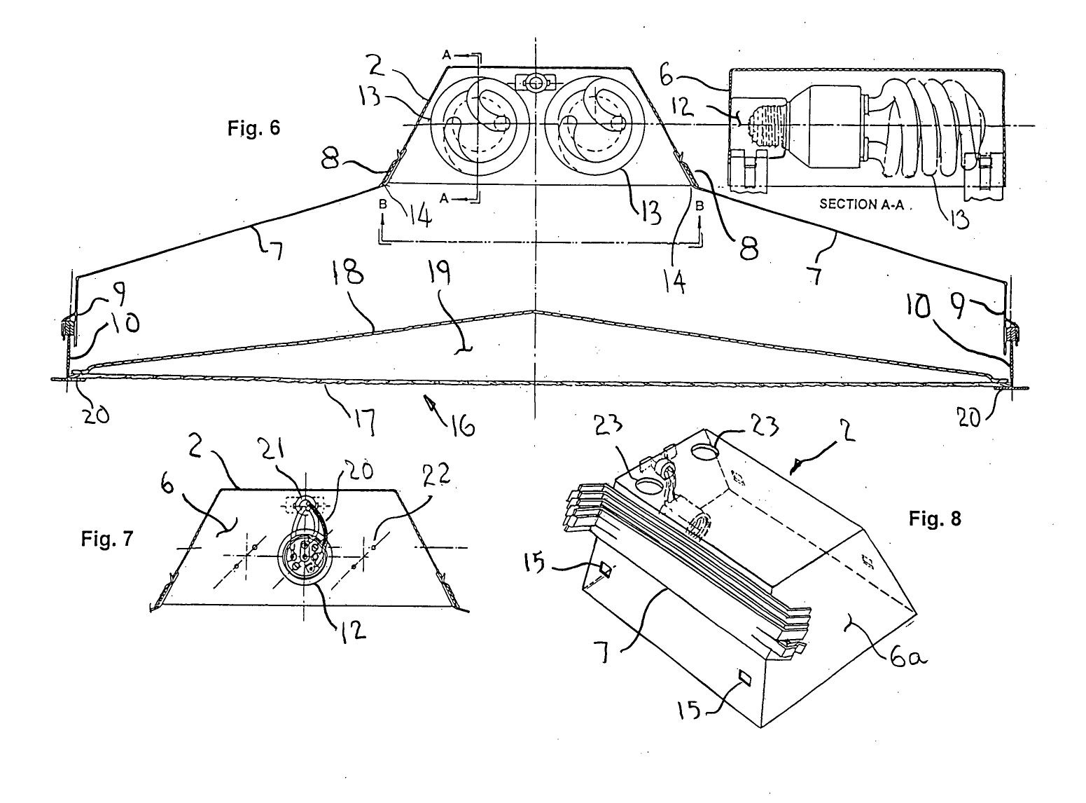

In FIG. 6 a cross-sectional view of FIG. 5 is shown having a first depending end (6) of housing (2) that includes one or more screw-base lampholders (12) connected to a remote source of electrical power (not shown). Each lampholder (12) holds and energizes a preferred self-ballasted, ballasted, screw-based compact fluorescent lamp (13). Angular struts (7) extend from housing (2) to the tops (11) of inverted T-bars (10) to support Housing (2) above a light-transmitting lens (16). Lens (16) is comprised of a lower panel (17) and an upper panel (18) as shown in the applicant's '349 patent. Lower panel (17) is preferably a generally flat, clear prismatic lens, and upper panel (18) is preferably a concave diffuser that diffuses the image of the light source and provides a heat-insulating air space (19) between the two panels, creating a thermal barrier closure supported on the lower flanges (20) of T-bar runners (10). In Section A-A of FIG. 6, light source (13) is illustrated as a spiral-type compact fluorescent lamp.

In FIG. 7 a cross-sectional view of housing (2) shows one preferred embodiment using a single lampholder (12) attached to depending end (6) of housing (2). Lampholder (12) may hold and energize a 3-way compact fluorescent lamp (24) operating as shown in applicant's prior art patent U.S. Pat. No. 4,178,535. Lampholder (12) is attached through one of 3 screw-hole patterns (22), permitting 1, 2, or 3 lampholders and lamps to be used. Energizing wires (20) are permanently attached to 3 contacts in the lampholder, and exit the housing through a conduit fitting (21). Thus, since there are no installer-used electrical connections within the housing, there is no need for a separate wiring compartment or junction box for the fixture.

In FIG. 8 a perspective view of housing (2) of fixture (1) is shown having convection cooling vents (23) to control lamp seal temperatures and extend lamp life. The detached struts (7) make a minimum-size and cost shipping package.

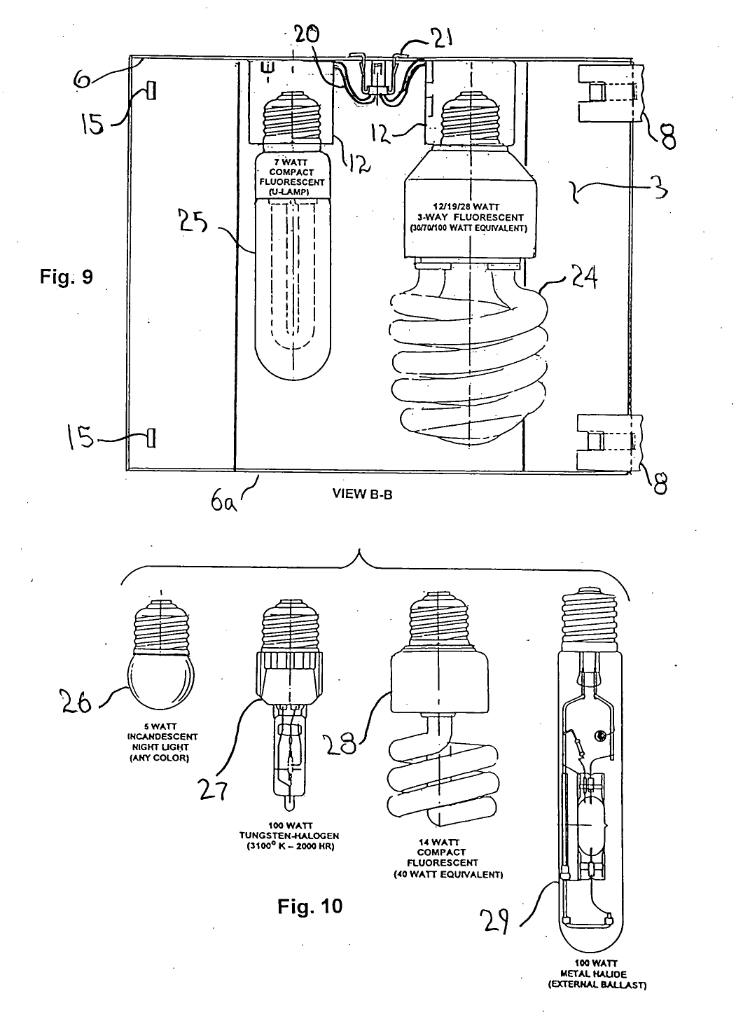

In FIG. 9, view B-B of FIG. 6, a 2-lamp option of the invention is shown to include a first lamp represented by a 3-way compact fluorescent lamp (24) having 12/24/28 watt modes to produce 30/60/100 watt incandescent light equivalents. A second lamp, represented by a 7 watt compact fluorescent U-lamp (25), is may serve as a night light or area stumble light. Since there is no switching in the fixture, the lamp and level selections are done with remote switching. Thus, for minimum energy use, the floor of a room may be illuminated to 1.25 fc (footcandles) by a low-level lamp (to meet the minimum light level required by the Americans With Disabilities Act), and working areas such as tables, desks or work benches may be illuminated continuously by higher wattage lamps, or with occupancy sensors to minimize energy use.

A number of optional lamps are shown in FIG. 10, including a 5-watt incandescent night light (26) that may be any continuous color to identify an area or sequentially-switched emergency exit path; a 100-watt tungsten-halogen lamp (27) that has a continuous, warm spectrum and a high CRI (color-rendition index) to offset the low CRI of a typical tri-stimulus fluorescent lamp (24, 25 or 28). It should be noted that any one-way lamp may be operated normally in a 3-way lampholder, as the lamp is connected only to the neutral screw shell and the center power contact. The 3-way intermediate contact simply hits the insulator between the lamp screw base and center electrode. Also shown in FIG. 10 is a metal-halide lamp that requires a special ceramic lampholder and an external ballast, intended for high ceiling applications requiring high light levels. However, a metal halide lamp can share the housing with a tungsten-halogen lamp to improve CRI, or a separately switched to reduce energy use with a low-level lamp in local areas that do not require high fc levels.

### ADVANTAGES OF THE INVENTION OVER PRIOR ART

The present invention as shown the figures is an energy-saving, compact, light-weight, inexpensive, spider-shaped light fixture for luminous ceilings.

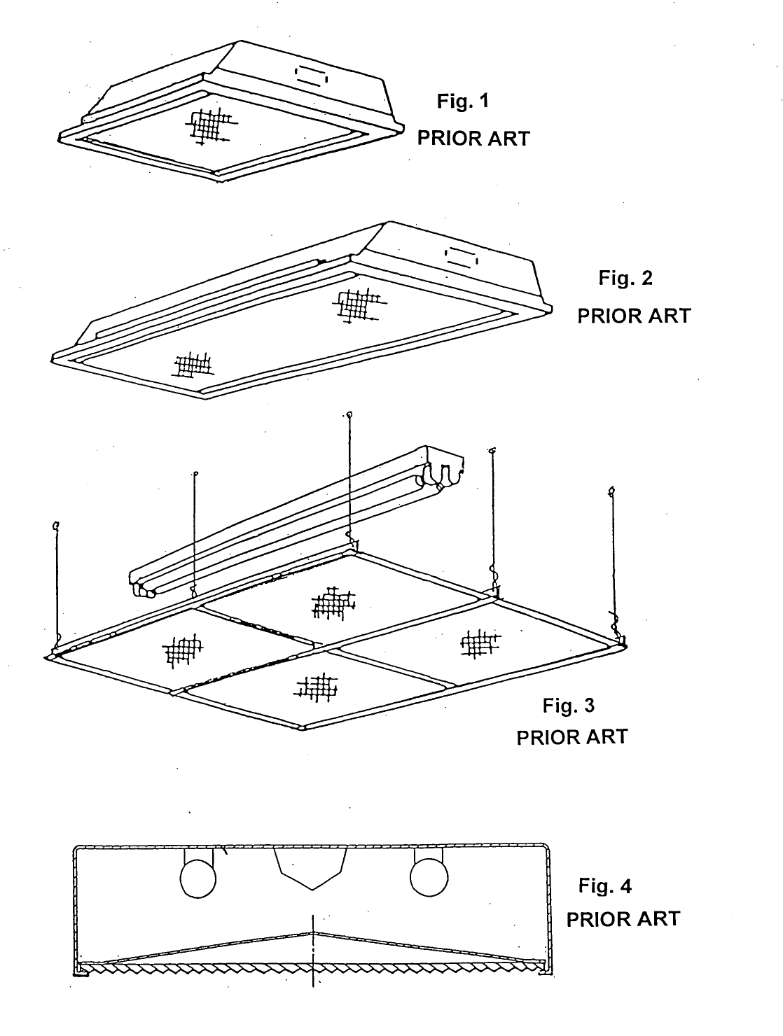

The typical 2×2 ft. prior art recessed fixture of FIG. 1 has approximately 1080 square inches of sheet metal and consumes 80 watts (2 ea. 40-watt fluorescent U-lamps). If one of the 2 lamps is turned off, the lens looks half dead. The present invention's fixture for a 2×2 T-bar grid has approximately 288 square inches of sheet metal and for the same light output consumes 56 watts (2 ea. 28-watt compact spiral fluorescent lamps). Since both lamps are near the center of the 2×2 lens that includes a diffuser, the lens is uniformly illuminated with one lamp operating. Thus the present invention fixture has ⅕^{th} the sheet metal, to fabricate, ⅕ the materials weight and 1/10^{th} the volume to package and ship, compared to the prior art fixture. Then the present invention can be switched to use 14 watts, 19 watts, 24 watts, 40 watts or 56 watts, depending on the desired light level under an individual fixture.

Compared to the 2×4 ft. prior art recessed fixture of FIG. 2, a pair of adjacent fixtures of the resent invention may be installed side-by-side by-side in the 2×8 grid opening, and still have approximately ⅕^{th} the materials weight and 1/10^{th} the packaged volume of the 2×4 ft. prior art fixture. Then the present invention can be switched to use 14 watts, 38 watts, 48 watts, 80 watts or 112 watts, depending on the desired light level under an individual 2×4 fixture.

1. A compact spider recessed light fixture (1) including:
a reflective, inverted U-shaped light source housing (2) having a central horizontal base (3), a pair of depending sides (4), extending downwards at an obtuse angle from the base of the U and having distal edges (5), a first depending end (6) closing the proximal end of the housing and supporting one or more screw-based lamps (13) in lampholders connectable to a remote source of power, and a second depending end (6a) closing the distal end of the housing;
a pair of elongated, angular depending struts (10) attached to the distal edge (5) of each depending side (4), each said strut having a bifurcated proximal end (11) in which a portion thereof (12) snaps into an aperture (13) in the distal respective depending end, each said strut also having a bifurcated distal end (14) in which a portion thereof (15) snaps onto an upstanding, bulbous portion (16) of an inverted T-bar ceiling runner (17) supporting each side of a light-transmitting luminous ceiling panel (18).

2. A light fixture according to claim 1 in which the lamps are optionally 3-way lamps in 3-way lampholders (12) in which power leads (20) are permanently attached to the lampholders and exit housing (2) through a conduit fitting (21) to a remote junction box connecting one or more fixtures (1) to a remotely-switched source of electrical power.

3. A light fixture according to claim 1 in which the luminous ceiling panel (18) comprises a pair of vertically-spaced lenses that transmit visible light and block invisible ultraviolet and infrared radiation.

4. A light fixture according to claim 1 in which the light-transmitting luminous ceiling panel (18) includes a lower prismatic lens and an upper diffusing lens having a perimeter in contact with the lower lens and having a central area spaced a above the lower lens.

5. A light fixture according to claim 1 in which the central horizontal base (3) of the housing (2) has one or more convection cooling vents (23).

6. A light fixture according to claim 1 in which the lamps (13) are selected from the group including incandescent lamps (26), tungsten-halogen lamps (27), compact fluorescent U-lamps (25), spiral-tube compact fluorescent lamps (24), light-emitting diodes (not shown) and gas-discharge lamps (29).
